(19) United States
(12) Patent Application Publication
(10) Pub. No.: US 2004/0198548 A1
(43) Pub. Date: Oct. 7, 2004

(54) Synchronizer having ball ramp actuator mechanism

(76) Inventors: Dan J. Showalter, Plymouth, MI (US); Soundararajan Vijayanarayanasamy, Utica, MI (US)

Correspondence Address: BORG WARNER INC., 3800 AUTOMATION AVENUE, SUITE 100, POWERTRAIN TECHNICAL CENTER, AUBURN HILLS, MI, 48236, US

(21) Appl. No.: 10/407,504

(22) Filed: Apr. 4, 2003

(51) Int. Cl. F16H 3/44; F16D 23/06

(52) U.S. Cl. 475/303; 192/53.31; 192/53.32

(57) ABSTRACT

A synchronizer for motor vehicle driveline components such as transmissions and transfer cases includes a pair of ball ramp mechanisms which amplify synchronizing force and apply such force to one of a pair of friction clutch packs which achieves synchronization of diversely rotating elements. The synchronizer exhibits relatively low operating force. Each ball ramp mechanism includes a pair of ball ramp members having rotational travel limits which also limit their axial separation and an intermediate compression spring assembly. The spring assembly and the travel limits of the ball ramp members limit the force generated by the ball ramp mechanisms and applied to the friction clutch packs to prevent abrupt and uncontrolled actuation of the friction clutch packs and corresponding abrupt synchronization of the rotating elements.

### BACKGROUND OF THE INVENTION

The invention relates generally to synchronizers for motor vehicle driveline components such as transmissions and transfer cases and more particularly to a synchronizer for such components having a ball ramp actuator mechanism.

It is frequently necessary in motor vehicle driveline components to connect one rotating member to another which is rotating at a different speed. In this situation, it is generally desirable to synchronize, or match, the speeds of the two rotating members prior to engagement to achieve a smooth engagement. Synchronizers for transmissions and transfer cases have existed for over seventy years. The most frequently encountered synchronizer is found in manual transmissions utilized in cars and trucks.

With the increasing sophistication of motor vehicle powertrain products, newer devices utilize sensors which monitor the speed of rotating members to be engaged and adjust, often by braking, the speed of one of the members to synchronize it with the other. In some drivetrains, electronic controllers capable of adjusting the speed of both the engine and transmission achieve synchronism of rotating members without the use of any mechanical synchronizer.

Notwithstanding such specialized devices, there is still a demand for synchronizers in, for example, transfer cases. A frequent requirement for transfer case synchronizers is rapid operation, that is, synchronization must be achieved typically within less than one second and such synchronizers must operate with relatively low applied force. As is often the case, these two requirements are mutually exclusive: a faster operating synchronizer generally necessitates a larger device with greater delivered force and energy requirements; a smaller device, though requiring less energy, typically generates less force and will require a longer time to achieve synchronization.

Accordingly, it is apparent that synchronizers exhibiting fast response time and low operating forces and power consumption are desirable.

### SUMMARY OF THE INVENTION

A synchronizer for motor vehicle driveline components such as transmissions and transfer cases includes a pair of ball ramp mechanisms which amplify synchronizing force and apply such force to one of a pair of friction clutch packs which achieves synchronization of diversely rotating elements. The synchronizer exhibits relatively low operating force. Each ball ramp mechanism includes a pair of ball ramp members having rotational travel limits which also limit their axial separation and an intermediate compression spring assembly. The spring assembly and the travel limits of the ball ramp members limit the force generated by the ball ramp mechanisms and applied to the friction clutch packs to prevent abrupt and uncontrolled actuation of the friction clutch packs and corresponding abrupt synchronization of the rotating elements.

Thus, it is an object of the present invention to provide a synchronizer for use with motor vehicle driveline components such as transmissions and transfer cases.

It is a further object of the present invention to provide a synchronizer having a ball ramp actuator mechanism and friction clutch packs.

It is a still further object of the present invention to provide a synchronizer having relatively low actuating force.

It is a still further object of the present invention to provide a synchronizer for motor vehicle driveline components having a pair of ball ramp mechanisms having both rotational and force limiting components.

It is a still further object of the present invention to provide a synchronizer for a motor vehicle driveline component having a pair of ball ramp mechanisms with stops which limit relative rotation of the ball ramp members.

Further objects and advantages of the present invention will become apparent by reference to the following description of the preferred embodiment and appended drawings wherein like reference numbers refer to the same component, element or feature.

### BRIEF DESCRIPTION OF THE DRAWINGS

FIG. 1 is a diagrammatic view of a motor vehicle driveline having a transfer case incorporating the present invention;

FIG. 2 is a full, sectional view of a motor vehicle transfer case incorporating a synchronizer according to the present invention;

FIG. 3 is an enlarged, fragmentary, sectional view of a synchronizer according to the present invention;

FIG. 4 is a greatly enlarged, fragmentary, sectional view of a synchronizer assembly according to the present invention;

FIG. 5 is a full, sectional view of a portion of a synchronizer according to the present invention taken along line 5-5 of FIG. 4; and

FIG. 6 is a flat pattern development of the ramped recesses and load transferring ball of one of the ball ramp actuators of a transfer case electromagnetic clutch taken along line 6-6 of FIG. 2.

### DESCRIPTION OF THE PREFERRED EMBODIMENT

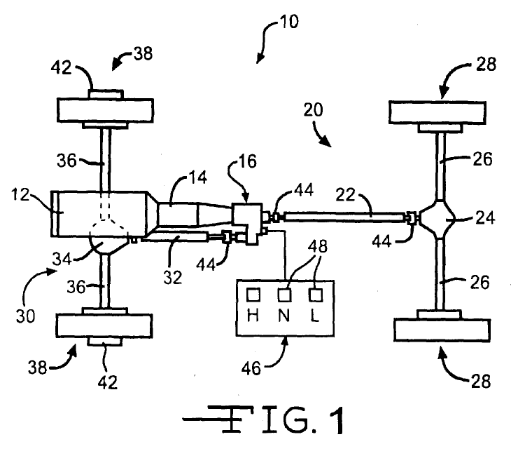

Referring now to FIG. 1, a four-wheel vehicle drive train is diagrammatically illustrated and designated by the reference number 10. The four-wheel vehicle drive train 10 includes a prime mover 12 which is coupled to and directly drives a transmission 14. The transmission 14 may either be an automatic or manual type. The output of the transmission 14 directly drives a transfer case assembly 16 which provides motive power to a primary or rear drive line 20 comprising a primary or rear prop shaft 22, a primary or rear differential 24, a pair of live primary or rear axles 26 and a respective pair of primary or rear tire and wheel assemblies 28.

The transfer case assembly 16 also selectively provides motive power to a secondary or front drive line 30 comprising a secondary or front prop shaft 32, a secondary or front differential assembly 34, a pair of live secondary or front axles 36 and a respective pair of secondary or front tire and wheel assemblies 38. The front tire and wheel assemblies 38 may be directly coupled to a respective one of the pair of front axles 36 or, if desired, a pair of manually or remotely activateable locking hubs 42 may be operably disposed between the pair of front axles 36 and a respective one of the tire and wheel assemblies 38 to selectively connect same. Finally, both the primary drive line 20 and the secondary drive line 30 may include suitable and appropriately disposed universal joints 44 which function in conventional fashion to allow static and dynamic offsets and misalignments between the various shafts and components. A control console 46 which is preferably disposed within convenient reach of the vehicle operator includes a switch or a plurality of individual switches or push buttons 48 which facilitate selection of the operating mode of the transfer case assembly 16 as will be further described below.

The foregoing and following description relates to a vehicle wherein the rear drive line 20 functions as the primary drive line, i.e., it is engaged and operates substantially all the time and, correspondingly, the front drive line 30 functions as the secondary drive line, i.e., it is engaged and operates only part-time or in a secondary or supplemental fashion, such a vehicle commonly being referred to as a rear wheel drive vehicle.

These designations “primary” and “secondary” are utilized herein rather than “front” and “rear” inasmuch as the invention herein disclosed and claimed may be readily utilized in transmissions and transfer cases wherein the primary drive line 20 is disposed at the front of the vehicle and the secondary drive line 30 is disposed at the rear of the vehicle. Such designations “primary” and “secondary” thus broadly and properly characterize the function of the individual drive lines rather than their specific locations.

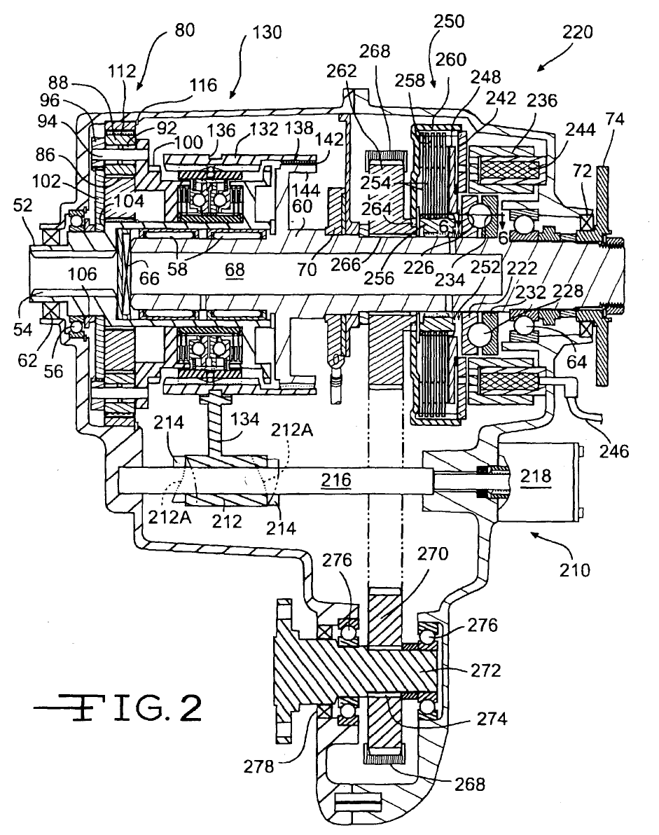

Referring now to FIGS. 1 and 2, the transfer case assembly 16 incorporating the present invention includes a multiple piece, typically cast, metal housing assembly 50 having planar and circular sealing surfaces, openings for shafts and bearings and various recesses, shoulders, flanges, counterbores and the like to receive various components and assemblies of the transfer case assembly 16. An input shaft 52 includes female or internal splines or gear teeth 54 or other suitable structure which drivingly couple an output of the transmission 14 (illustrated in FIG. 1) to the input shaft 52. The input shaft 52 is rotatably supported externally by an anti-friction bearing such as a ball bearing assembly 56 and internally by an anti-friction bearing such as a roller bearing assemblies 58. The roller bearing assemblies 58 are disposed upon a reduced diameter portion of a primary output shaft 60. An oil seal 62, positioned between the input shaft 52 and the housing assembly 50, provides an appropriate fluid tight seal therebetween.

The opposite end of the output shaft 60 is supported by an anti-friction bearing such as a ball bearing assembly 64. An end cap or seal 66 closes off the end of an axial passageway 68 in the primary output shaft 60. A gerotor pump 70 will typically be utilized to provide a flow of lubricating and cooling fluid to the axial passageway 68 which is thence distributed through a plurality of radial ports in the primary output shaft 60 to the components of the transfer case assembly 16. An oil seal 72 positioned between the housing 50 and an output feature such as a flange 74 achieves a seal between the housing 50 and the primary output shaft 60.

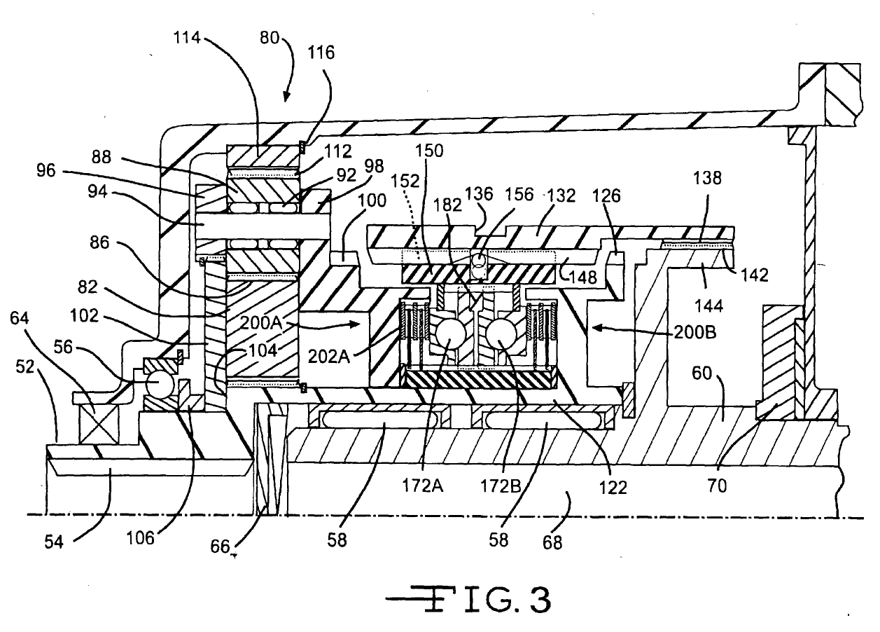

Referring now to FIGS. 2 and 3, the transfer case assembly 16 includes a planetary gear speed reduction assembly 80. The planetary gear speed reduction assembly 80 includes a sun gear 82 which may be a collar coupled by interengaging splines 84 to the input shaft 52 or may be integrally formed therewith. The sun gear 82 includes gear teeth 86 which are in constant mesh with a plurality of pinion or planet gears 88. The planet gears 88 may be rotatably disposed upon roller bearings 92 which in turn are supported by fixed stub shafts 94 or the pinion gears 88 may be rotatably supported directly upon the stub shafts 84, if desired. The stub shafts 94 are retained and secured within a planet carrier 96 which includes a bell shaped extension 98 and male or external splines or gear teeth 100. The planet carrier 96 is also supported by a circular disc 102 which engages a shoulder 104 on the input shaft 52 on one side and is axially positioned by a spacer 106 on its opposite side.

The plurality of pinion or planet gears 88 are in constant mesh with gear teeth 112 of a stationary ring gear 114 which is secured within the housing 50 by, for example, a snap ring 116.

The input shaft 52 includes an elongate sleeve or quill 122. The sleeve or quill 122 is rotatably supported by the a pair of roller bearing assemblies 58. The sleeve or quill 122 of the input shaft 52 includes male splines or gear teeth 126 which are spaced from and axially aligned with the male splines or gear teeth 100 on the planet gear carrier 96.

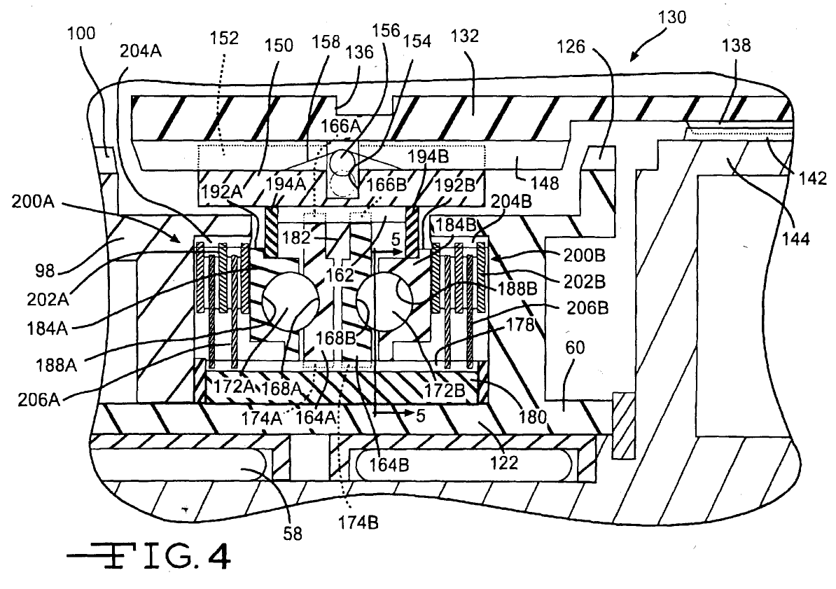

Referring now to FIGS. 3 and 4, the transfer case assembly 16 also includes a synchronizer assembly 130. The synchronizer assembly 130 includes an outer annular shift collar 132 which may be bi-directionally translated from its center position by corresponding bidirectional motion of a shift fork 134 which is received within a circumferential channel or groove 136. The annular shift collar 132 includes internal or female splines or gear teeth 138 which are complementary to and in constant engagement with male or external splines or gear teeth 142 formed on an annular member 144 of the primary output shaft 60. The annular shift collar 132 also includes internal or female splines or gear teeth 148 which are complementary to and axially aligned with the male splines 100 on the planetary gear carrier 96 and the male splines 126 on the input shaft sleeve or quill 122. An inner detented collar 150 having external or male splines or gear teeth 152 is received within and rotates with the annular shift collar 132. The detented collar 150 includes a circumferential channel 154 which is capable of receiving a contractable circumferential spring 156 which, in its relaxed state, resides within a shallow, oblique-walled circumferential recess 158 in the outer annular shift collar 132. The circumferential groove 154, the contractable spring 156 and the oblique-walled circumferential recess 158 cooperate to provide a detenting action between the detented collar 150 and the annular shift collar 132 which provides some resistance to motion of the detented collar 150, when it is moved out of the position illustrated in FIG. 3 and assists return of the detented collar 150 to the center position illustrated in FIG. 3.

Referring now to FIGS. 3, 4 and 5, centrally disposed on the inner surface of the detented collar 150 is a region of axially extending internal or female splines or gear teeth 162. The splines or gear teeth 162 engage first or inner left and right circular ball ramp members 164A and 164B which include splines 166A and 166B complementary to and engaged with the female splines or gear teeth 162 on the detented collar 150. The circular members 164A and 164B include a plurality of oblique walled, ramped recesses 168A and 168B which receive a like plurality of load transferring balls 172A and 172B. Preferably, the ramped recesses 172A and 172B extend angularly over approximately 90° to 100°. The circular members 164A and 164B also include internal or female splines or gear teeth 174A and 174B which engage complementarily configured male or external splines or gear teeth 178 on a collar or hub 180 which is freely rotatably disposed upon the input shaft sleeve or quill 122. The splines or gear teeth 178 are non-standard in that only three splines or gear teeth 178 disposed at 120° intervals reside on the collar or hub 180. It will be appreciated that the primary output shaft 60, the annular shift collar 132, the detented collar 150, the first or inner clutch members 164A and 164B and the collar or hub 180 all rotate together.

Operably disposed between the adjacent faces of the first or inner left and right circular ball ramp members 164A and 164B is a compression spring 182. The compression spring 182 may be a Belleville washer, a wave washer or a circular disc having a plurality of small compression springs disposed along axes parallel to and equidistant from the center line of the primary output shaft 60.

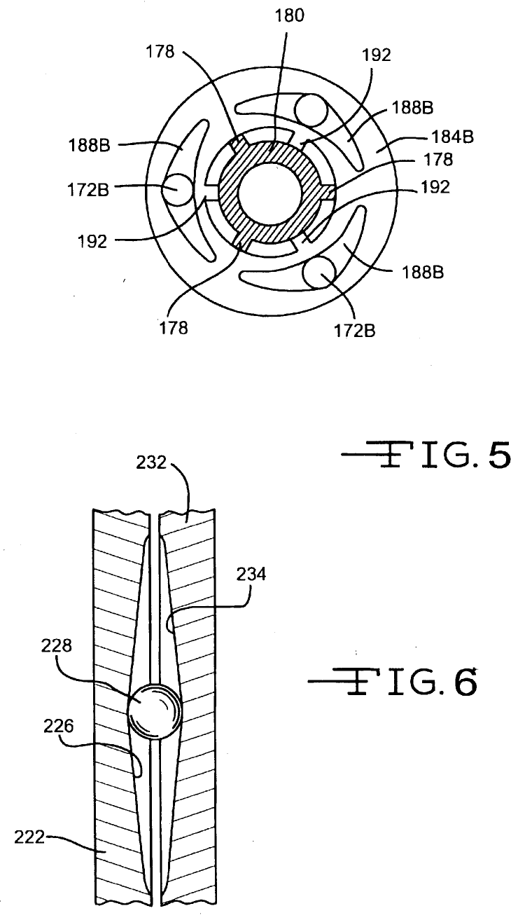

The synchronizer assembly 130 also includes second or outer left and right circular ball ramp members 184A and 184B each having a corresponding plurality of oblique walled, ramped recesses 188A and 188B. Preferably, the ramped recesses 188A and 188B extend angularly over approximately 90° to 100°. As illustrated in FIG. 5, the three male or external splines 178 spaced at 120° intervals engage with a corresponding number, i.e., three, spaced apart splines 192 on each of the pair of second circular members 184A and 184B. Accordingly, the second circular members 184A and 184B are free to rotate through a limited range of travel relative to the collar or hub 180. Such range of travel is on the order of 80 to 90 angular degrees and thus the relative rotation and the axial displacement of the circular members 164A and 164B relative to the corresponding circular member 184A and 184B are limited.

It will be appreciated that the ramped recesses 168A, 168B, 188A and 188B and the load transferring balls 172A and 172B may be replaced with other analogous mechanical elements which cause axial displacement of the circular members 164A, 164B, 184A and 184B in response to relative rotation therebetween. For example, tapered rollers disposed in complementarily configured conical helices may be utilized.

Each of the second or circular outer members 184A and 184B includes a respective shoulder 192A and 192B which traps and engages a corresponding flat washer 194A and 194B. The opposite faces of each of the flat washers 194A and 194B engage the internal splines or gear teeth 162 on the inner detented collar 150. Thus, as the detented collar 150 moves to the left or right from the position illustrated in FIG. 3, the female or internal splines or gear teeth 162 engage and translate one of the flat washers 194A or 194B in a direction corresponding to the direction of travel of the detented collar 150 and correspondingly translate one of the second or outer circular members 184A or 184B into engagement with a corresponding left and right friction clutch pack 200A or 200B.

The left and right friction clutch packs 200A and 200B include a first plurality of larger clutch plates or discs 202A and 202B. The larger friction plates or discs 202A on the left engage complementarily configured splines or gear teeth 204A on the bell shaped portion 98 of the planet carrier 96. A second plurality of smaller diameter friction clutch plates or discs 206A on the left engage the splines 178 on the collar or hub 180. Correspondingly, a first set of larger friction clutch plates or discs 202B on the right engage a complementary plurality of internal or female splines or gear teeth 204B on the elongate quill or sleeve 122 of the input shaft 52. A second, interleaved plurality of smaller diameter friction clutch plates or discs 206B on the right also engage the splines 178 on the collar or hub 180.

Referring again to FIG. 2, the shift fork 134 is part of a shift operator assembly 210. The shift fork 134 extends radially from a cylindrical body 212 having a pair of identical cams 212A at each end. The cams 212A are engaged by a pair of spaced apart cam followers 214 which are secured to a bi-directionally rotatable shift shaft or rail 216. The shift rail 216 is bi-directionally rotated by an electric motor drive mechanism 218 which selectively, bi-directionally rotates the shift rail 216 and axially translates the shift fork 134 to axially, bi-directionally, move the outer elongate shift collar 132.

Referring now to FIGS. 2 and 6, the transfer case assembly 16 also includes an electromagnetically actuated disc pack type clutch assembly 220 which effects selective torque transfer from the primary output shaft 60 to the secondary drive line 30. The disc pack clutch type assembly 220 is disposed about the primary output shaft 60 and includes a circular drive member 222 coupled to the primary output shaft 60 through, for example, a splined interconnection. The circular drive member 222 includes a plurality of circumferentially spaced-apart recesses 226 in the shape of an oblique section of a helical torus. Each of the recesses 226 receives one of a like plurality of load transferring balls 228.

A circular driven member 232 is disposed adjacent the circular drive member 222 and includes a like plurality of opposed recesses 234 defining the same shape as the recesses 226. The oblique side walls of the recesses 226 and 234 function as ramps or cams and cooperate with the balls 228 to drive the circular members 222 and 232 apart in response to relative rotation therebetween. It will be appreciated that the recesses 226 and 234 and the load transferring balls 228 may be replaced with other analogous mechanical elements which cause axial displacement of the circular members 222 and 232 in response to relative rotation therebetween. For example, tapered rollers disposed in complementarily configured conical helices may be utilized.

The circular driven member 232 extends radially outwardly and is secured to a soft iron rotor 236. An armature 242 is disposed adjacent the face of the rotor 236. The rotor 236 surrounds an electromagnetic coil 244 on three sides.

The electromagnetic coil 244 is provided with electrical energy preferably from a pulse width modulation (PWM) controller through an electrical conductor 246. The pulse width modulation scheme increases or decreases the average current to the electromagnetic coil 244 of the electromagnetic clutch assembly 220 and thus the torque throughput of the disc pack type clutch assembly 220, as will be more fully described below, by increasing or decreasing the on time (duty cycle) of a drive signal. It will be appreciated that other modulating control techniques may be utilized to achieve engagement and disengagement of the electromagnetic disc pack type clutch assembly 220.

Providing electrical energy to the electromagnetic coil 244 causes magnetic attraction of the armature 242 with the rotor 236. This magnetic attraction results in frictional contact of the armature 242 to the rotor 236. When the primary output shaft 60 is turning at a different speed than the armature 242 this frictional contact results in a frictional torque being transferred from the primary output shaft 60, through the circular drive member 222, through the load transferring balls 228 and to the circular driven member 232. The resulting frictional torque causes the balls 228 to ride up the ramps of the recesses 226 and 234, causing axial displacement of the circular drive member 222. Axial displacement of the circular drive member 222 translates an apply plate 248 axially toward a disc pack clutch assembly 250. A compression spring 252 which may comprise a stack of Belleville washers provides a restoring force which biases the circular drive member 222 toward the circular driven member 232 and returns the load transferring balls 228 to center positions in the circular recesses 226 and 234 to provide maximum clearance and minimum friction between the components of the electromagnetic clutch assembly 220 when it is deactivated. An important design consideration of the recesses 226 and 234 and the balls 228 is that the geometry of their design and the design of the compression spring 252 and the clearances in the disc pack assembly 250 ensure that the electromagnetic clutch assembly 220 is not self-locking. The electromagnetic clutch assembly 220 must not self-engage but rather must be capable of controlled, proportional engagement and torque transfer in direct response to the modulating control input.

The disc pack clutch assembly 250 includes a first plurality of smaller friction plates or discs 254. The first plurality of discs 254 are coupled by interengaging splines to a clutch hub 256 which is coupled to the primary output shaft 60 for rotation therewith. A second plurality of larger friction plates or discs 258 are coupled to an annular housing 260 by interengaging splines for rotation therewith and are interleaved with the first plurality of friction discs 254.

The annular housing 260 is disposed concentrically about the primary output shaft 60 and is coupled to a chain drive sprocket 262 by a plurality of interengaging splines or lugs and recesses 264. The chain drive sprocket 262 is freely rotatably disposed on the primary output shaft 60 and is supported by a journal or needle bearing assembly 266. When the clutch assembly 220 is engaged, it transfers torque from the primary output shaft 60 to the chain drive sprocket 262. A drive chain 268 is received upon the chain drive sprocket 262 and engages and transfers energy to a driven chain sprocket 270. The driven chain sprocket 270 is coupled to a front or secondary output shaft 272 of the transfer case assembly 16 by interengaging splines 274. The secondary output shaft 272 is rotatably supported by a pair of roller bearing assemblies 276 and an oil seal 278 provides a fluid tight seal between the secondary output shaft 292 and the housing 50.

In operation, the synchronizer assembly 130 according to the present invention provides rapid synchronism while utilizing relatively low engagement force. Thus, the associated shift operator may be lighter, smaller and exhibit lower power consumption than many conventional designs. When a shift is commanded, the shift fork 134 begins to move the outer annular shift collar 132 to the right or to the left from the position illustrated in FIGS. 2, 3 and 4. In the following explanation, it will be assumed that the outer annular shift collar 132 is being moved to the left as illustrated in FIGS. 2, 3 and 4 to engage the reduced speed output from the carrier 96 of the planetary gear speed reduction assembly 80. Translation of the outer annular shift collar 132 to the right engages direct drive from the input shaft 52 but the action of the synchronizer assembly 130 is essentially the same.

As the outer annular shift collar 132 moves to the left, the contractable spring 156 is driven by the oblique sidewalls 158 into the circumferential channel 154 of the inner detented collar 150. The detented collar 150 likewise begins to move to the left and the female or internal splines or gear teeth 162 translate the flat washer 194A which in turn, translates the second or outer left circular ball ramp member 184A into increased frictional engagement with the left friction clutch pack 200A. The drag so created causes relative rotation between the outer circular ball ramp member 184A and the inner circular ball ramp member 164A causing the load transferring balls 172A to axially separate the circular members 164A and 184A.

Both the relative rotation of the inner and outer circular members 164A and 184A and thus their axial separation is limited by the cooperative action of the splines 178 and 192. The axial separation of the inner and outer circular members 164A and 184A compresses the friction clutch pack 200A and begins to drive the planetary gear carrier 96 into synchronism with the primary output shaft 60. The compressive force applied to the friction clutch pack assembly 200A is controlled and limited by the compressive force generated by the compression spring 182 and, in fact, can be no greater than that force generated by the compression spring 182. It must be appreciated that the adjacent first or inner circular members 164A and 164B must not be permitted to touch or contact one another as this would allow force in excess of that controlled or limited by the compression spring 182 to be applied to the friction clutch packs 200A and 200B and provide abrupt and unacceptable synchronizer operation.

In this regard, it should also be appreciated that selection of the spring rate of the compression spring 182 will control the force applied to the friction clutch packs 200A and 200B and thus the relative speed of synchronization achieved by the synchronizer assembly 130. That is, a higher or stiffer spring rate will allow more force to be applied to the friction clutch packs 200A and 200B resulting in faster synchronization and a lower or softer spring rate will achieve a slower rate of synchronization.

When the speed of the planet carrier 96 matches that of a primary output shaft 60, the outer annular shift collar 132 may be further advanced to the left such that the female or internal splines or gear teeth 148 may be engaged with the male splines or gear teeth 100 on the planetary gear carrier 96. In this condition, drive torque is transferred directly from the planetary gear carrier 96 through the outer annular shift collar 132, through the inter-engaging splines 138 and 142 and to the primary output shaft 60.

The foregoing disclosure is the best mode devised by the inventors for practicing this invention. It is apparent however, that devices incorporating modifications and variations will be obvious to one skilled in the art of mechanical synchronizers. Inasmuch as the foregoing disclosure presents the best mode contemplated by the inventors for carrying out the invention and is intended to enable any person skilled in the pertinent art to practice this invention, it should not be construed to be limited thereby but should be construed to include such aforementioned obvious variations and be limited only by the spirit and scope of the following claims.

We claim:

1. A synchronizer for motor vehicle drive line components comprising, in combination,
a first drive member,
a second drive member,
an output member,
a clutch collar adapted to drive said output member and selectively engage one of said first and said second drive members,
a pair of ball ramp mechanisms each including a pair of adjacent members each defining a plurality of opposing ramped recesses, a like plurality of load transferring members disposed in said recesses, one of each of said pair of adjacent members disposed for rotation with said output member,
a compression spring operably disposed between said pair of ball ramp mechanisms,
a pair of friction clutch packs each including first and second interleaved sets of clutch plates, one of said sets of clutch plates disposed for rotation with each of said drive members and another of said sets of clutch plates disposed for rotation with said output member, and
an inner collar associated with said clutch collar for selectively translating another of each of said pair of adjacent members toward an adjacent one of said friction clutch packs.

2. The synchronizer of claim 1 wherein said compression spring is a Belleville washer.

3. The synchronizer of claim 1 wherein said compression spring is a disc having a plurality of compression springs having axes disposed parallel to and offset from an axis of said output member.

4. The synchronizer of claim 1 further including a detent operably disposed between said clutch collar and said inner collar.

5. The synchronizer of claim 1 further including means for limiting relative rotation between said pair of adjacent members of each of said pair of ball ramp mechanisms.

6. The synchronizer of claim 1 further including a shift fork operably engaging said clutch collar and an actuator for bi-directionally translating said shift fork and said clutch collar.

7. The synchronizer of claim 1 further including pluralities of inter-engaging splines on said output member and said clutch collar.

8. The synchronizer of claim 1 further including inter-engaging splines on said clutch collar and said first drive member and said second drive member.

9. The synchronizer of claim 1 wherein said first drive member is a reduced speed output of a planetary gear speed reduction assembly and said output member is a primary output shaft of a transfer case.

10. The synchronizer of claim 1 wherein said pair of friction clutch packs are disposed adjacent a respective one of said pair of ball ramp mechanisms.

11. A synchronizer for a motor vehicle transfer case comprising, in combination,
a planetary gear speed reduction assembly having a first drive member,
an input shaft having a second drive member,
a primary output shaft,
a clutch collar rotationally coupled to said primary output shaft and translatable into driven engagement with one of said first and said second drive members,
a shift collar disposed within and coupled to said clutch collar for rotation therewith,
a pair of ball ramp mechanisms each including a pair of relatively rotatable inner and outer adjacent members, each of said members defining a plurality of ramped recesses adapted to receive a like plurality of load transferring members, each of said adjacent inner members coupled for rotation with said shift collar,
a compression spring disposed between adjacent inner members of said pair of ball ramp mechanisms,
a pair of friction clutch packs disposed adjacent a respective one of said outer members of said ball ramp mechanisms, each of said friction clutch packs including first clutch discs disposed for rotation with said inner members of said pair of ball ramp mechanisms and a second plurality of interleaved clutch plates, one of said pluralities of clutch plates of one of said friction clutch packs disposed for rotation with said first drive member and another plurality of friction clutch plates of said other friction clutch pack disposed for rotation with said second input member,
whereby translation of said clutch collar and said inner collar causes relative rotation between one of said pairs of adjacent clutch members, compression of one of said friction clutch packs and synchronism between one of said drive members and said output member.

12. The synchronizer for a motor vehicle transfer case of claim 11 further including a detent assembly operably disposed between said clutch collar and said shift collar.

13. The synchronizer for a motor vehicle transfer case of claim 11 wherein said compression spring is a Belleville washer.

14. The synchronizer for a motor vehicle transfer case of claim 11 wherein said compression spring is a disc having a plurality of compression springs having axes disposed parallel to and offset from an axis of said output member.

15. The synchronizer for a motor vehicle transfer case of claim 11 further including means for limiting relative rotation between said pair of adjacent members of each of said pair of ball ramp mechanisms.

16. The synchronizer for a motor vehicle transfer case of claim 11 further including a shift fork operably engaging said clutch collar and an actuator for bi-directionally translating said shift fork and said clutch collar.

17. The synchronizer for a motor vehicle transfer case of claim 11 further including pluralities of inter-engaging splines on said primary output shaft and said clutch collar.

18. The synchronizer for a motor vehicle transfer case of claim 11 further including engagable splines on said clutch collar and said first drive member and said second drive member.

19. A synchronizer for drive line components comprising, in combination,
a first drive member,
a second drive member,
an output member,
a clutch device drivingly engaging said output member and adapted to selectively engage one of said first and said second drive members,
a pair of ball ramp mechanisms each including a pair of adjacent relatively rotatable members defining a plurality of opposed oblique ramps, a like plurality of load transferring members disposed on said oblique ramps, one of each of said pair of adjacent members operably coupled to said output member for rotation therewith,
a compression spring operably disposed between said pair of ball ramp mechanisms,
a pair of friction clutch packs disposed adjacent a respective one of said ball ramp mechanisms, each of said friction clutch packs including first and second interleaved sets of clutch plates, one of said sets of clutch plates disposed for rotation with each of said drive members and another of said sets of clutch plates disposed for rotation with said output member, and
an inner collar associated with said clutch device for selectively translating another of each of said pair of adjacent members of said ball ramp mechanisms toward said adjacent friction clutch pack, whereby said compression spring limits force applied by said ball ramp mechanisms to said adjacent friction clutch packs.

20. The synchronizer for drive line components of claim 19 wherein said compression spring is a Belleville washer.

21. The synchronizer for drive line components of claim 19 wherein said compression spring is a disc having a plurality of compression springs having axes disposed parallel to and offset from an axis of said output member.

22. The synchronizer for drive line components of claim 19 wherein said first drive member is an output of a planetary gear speed reduction assembly and said output member is a primary output shaft of a transfer case.

23. The synchronizer for drive line components of claim 19 further including means for limiting relative rotation between said pair of adjacent members of each of said pair of ball ramp mechanisms.

24. The synchronizer for drive line components of claim 23 wherein said means for limiting relative rotation includes sets of angularly spaced apart inter-engaging splines

25. The synchronizer for drive line components of claim 19 further including a shift fork operably engaging said clutch device and an actuator for bi-directionally translating said shift fork and said clutch device.

26. The synchronizer for drive line components of claim 19 further including an electromagnetic clutch for selectively providing drive torque from said output member to a second output member.
